(19) United States
(12) Patent Application Publication
(10) Pub. No.: US 2018/0251142 A1
(43) Pub. Date: Sep. 6, 2018

(54) RAIL CAR PREDICTIVE MAINTENANCE SYSTEM

(71) Applicant: New York Air Brake, LLC, Watertown, NY (US)

(72) Inventors: Keith Wesley Wait, Flower Mound, TX (US); Bradley Howard, Haslet, TX (US)

(73) Assignee: New York Air Brake, LLC, Watertown, NY (US)

(21) Appl. No.: 15/448,642

(22) Filed: Mar. 3, 2017

(51) Int. Cl. B61L 27/00; B61K 9/02; B61L 25/02; B61L 25/04; B61H 1/00; G01L 5/28

(52) U.S. Cl. CPC B61L 27/0094; B61K 9/02; B61L 25/025; B61L 25/04; G01L 5/284; B61H 1/00; B61L 27/0005; B61L 27/0077; B61L 25/021

(57) ABSTRACT

A predictive maintenance system for determining when an item of equipment on a rail car is due for servicing. A server is configured to receive run data relating to a train and a database is associated with the server to maintain identifying information about the rail car, status information about an item of equipment, the date when the item of equipment will likely be due for servicing, and the current location of the rail car. The service date is calculated from the run data by estimating the amount of wear that likely has occurred based on the run data. The estimated amount of wear may then be used to determine the amount of wear remaining and the date when the equipment will likely reach its lifespan based on estimated use to date and the rate of usage.

### BACKGROUND OF THE INVENTION

### 1. Field of the Invention

The present invention relates to rail car maintenance systems and, more particularly, a system for predicting the need for maintenance based on recreated simulated operations.

### 2. Description of the Related Art

The periodic maintenance of rail cars requires that each rail car that is due for repairs must be taken out of service, which results in a loss in revenue due to the lost service of the rail car while it is out of service. This problem is exacerbated when an inspection of a rail car determines that it is due for service but the rail car is not in a location where it may be readily serviced. The rail car must then be taken out of service and transported, sometimes a great distance, to a maintenance yard where it can be serviced. Accordingly, there is a need for a system that can accurately predict when each rail car is likely to become due for service so that railroad companies can schedule the location of the rail car to reduce down time and other costs associated with the maintenance process.

### BRIEF SUMMARY OF THE INVENTION

The present invention comprises a predictive maintenance system for determining when an item of equipment on a rail car is due for servicing. The system includes a server configured to receive run data relating to a train including at least one rail car from a train control system. A database associated with the server contains identifying information about the rail car, various status information about an item of equipment on the rail car, the date when the item of equipment is due to be serviced, and the current location of the rail car. The server is programmed to update the status information, the date when the item of equipment is due to be serviced, and the current location of the rail upon receipt of any new run data that is received from the train control system. The identifying information preferably comprises a rail car identification number, the item of equipment comprises a brake shoe, and the run data comprises the load carried by the rail car, the speed of the rail car, and the amount of braking effort provided by the rail car. The date when the item of equipment is due to be serviced is calculated from the run data by determining the estimated amount of wear that likely has occurred based on the load carried by the rail car, the speed of the rail car, and the amount of braking effort provided by the rail car. The estimated amount of wear of the brake shoe is then subtracted from the lifetime amount of wear for the brake shoe to determine an amount of wear remaining. The date when the brake shoe will likely reach the end of its lifespan may then be determined by determining the rate of wear of the brake shoe over time and extrapolating the rate of wear over the remaining lifespan of the brake shoe.

The invention also includes a method of predicting when rail car equipment will need maintenance involving the steps of providing a server configured to receive run data relating to a train including at least one rail car from a train control system and a database associated with the server and containing identifying information about the rail car, status information about an item of equipment on the rail car, a date when the item of equipment is due to be serviced, and a current location of the rail car, calculating the amount of wear that the item of equipment will experience based on the run data, and then updating the status information, the date when the item of equipment is due to be serviced, and the current location of the rail upon receipt of run data from the train control system based on the calculation of the amount of wear that the item of equipment will experience. The method can include the step of predicting how much time remains before the item of equipment will need to be serviced, where the step of the step of predicting how much time remains before the item of equipment will need to be serviced comprises determining an accumulated amount of wear over a series of braking events and extrapolating when the accumulated amount of wear of the brake shoe will reach a total amount of allowable wear.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic showing a system for predicting rail car maintenance according to the present invention;

FIG. 2 is a schematic of server management for a system for predicting rail car maintenance according to the present invention;

FIG. 3 is a schematic of a rail car database for a system for predicting rail car maintenance according to the present invention; and

FIG. 4 is a graph of an exemplary rail car maintenance prediction algorithm according to the present invention;

FIG. 5 is a graph of the frictional characteristic of a brake shoe expressed as a function of wheel velocity;

FIG. 6 is a graph of predicted remaining brake shoe life as a plot of the accumulated brake shoe wear using a linear regression model;

FIG. 7 is schematic of a system for predicting rail car maintenance that includes a parts module that tracks the equipment that is due to be serviced according to the present invention.

### DETAILED DESCRIPTION OF THE INVENTION

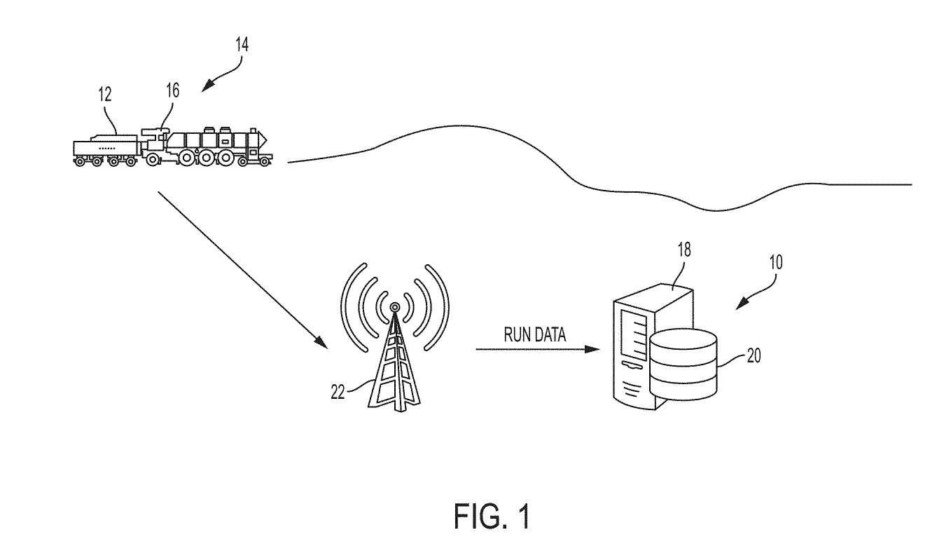

Referring now to the drawings, wherein like reference numerals refer to like parts throughout, there is seen in FIG. 1 a schematic of a system 10 for predicting when one or more rail cars 12 used in a train 14 are likely to become due for service. System 10 is interconnected to a conventional train control system 16, such as the LEADER train control system available from New York Air Brake of Watertown, N.Y., which maintains the identification (ID) of each rail car 12 in a train 14 and collects data about the actual operation of train 14 over a given route, including the load of each rail car 12, the number of times the brakes of each rail car 12 are applied, and the length of time the brakes were applied during each brake application. System 10 generally includes a trail car maintenance server 18 and associated database 20 that can communicate with train control system 16, such as via wireless communication systems 22, to obtain run data regarding the operation of train 14 and each rail car 12 whose maintenance schedule is to be tracked for predictive purposes.

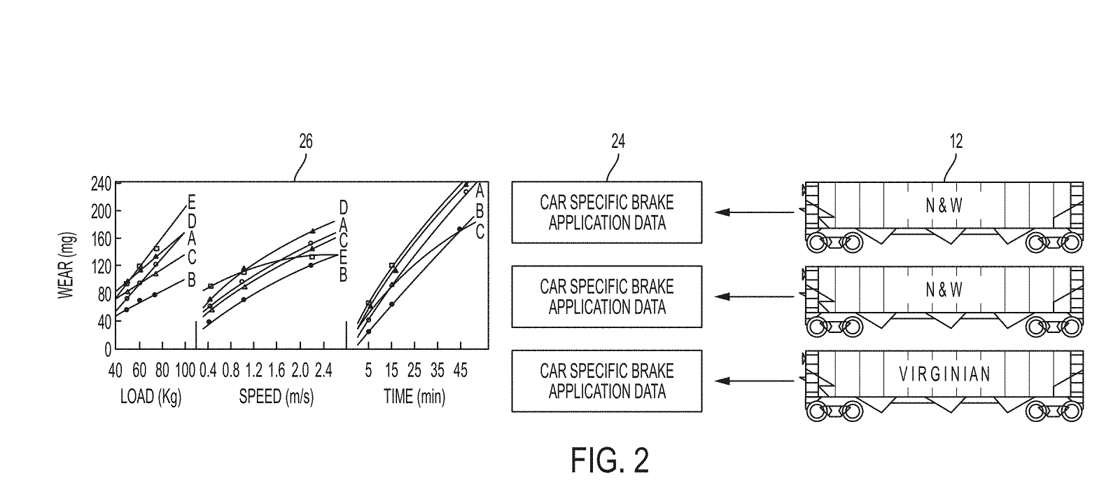

Referring to FIG. 2, server 18 manages information about each rail car 12, such as identifying information and equipment details, as well as run data uploaded from train 14 via wireless communication routes available to existing train control systems 16. Using run data, server 18 can calculate car specific brake application data 24 for each rail car 12. For example, as seen in FIG. 2, server 18 can determine the amount of wear experienced by the brakes of rail car 12 by analyzing certain run data 26, such as the load data, train speed, and time of braking. This information may be tracked, such as in database 20, to keep a constant tally for each rail car 12.

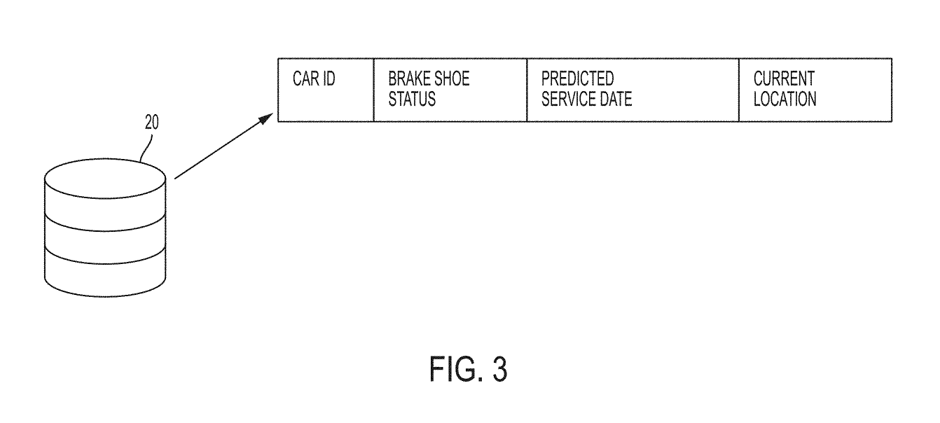

Referring to FIG. 3, database 20 associated with server 18 can track, such as by a car identifier, the status of the each item of equipment on each rail car 12, the predicted date when each item of rail car equipment will need service, and the current location of rail car 12. For example, as seen in FIG. 3, the item of equipment may comprise a brake shoe whose wear over time is calculated based on run data obtained from train 14 to determine the status of the brake shoe, the predicted service data for the brake shoe, and the current location of rail car 12 having that brake shoe.

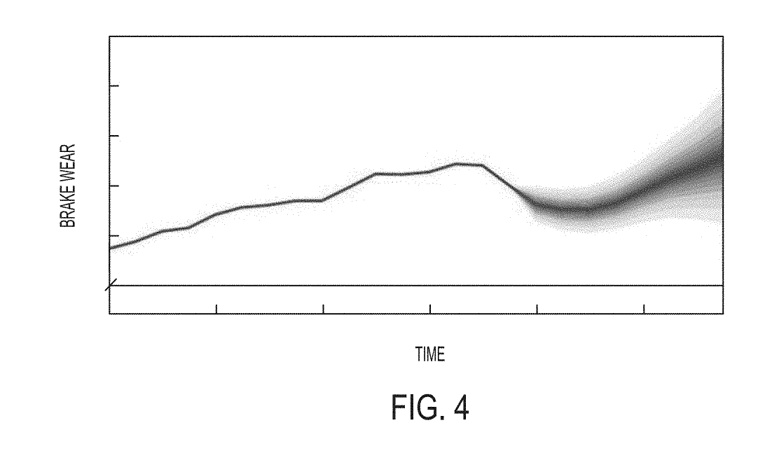

Referring to FIG. 4, the predicted date when service will be required is determined by system 10 using a prediction algorithm that takes into account the lifespan of the equipment, the date when it was placed in service, and the use of the equipment based on the information provided by train control system 16. For example, brake wear may be determined based on the data when a particular brake shoe was placed into service and the amount of braking that the particular rail car 12 on which the brake shoe is installed has undergone while part of train 14. The amount of wear remaining before the brake shoe will need to be replaced may be calculated by subtracting the amount of wear that has liked occurred to date (based on the amount of braking that the brake shoe has actually experienced) from the expected lifespan of a brake shoe of the same type. System 10 can then predict the date when the brake shoe will likely need to be replaced by determining how long it will take for the remaining life span of the brake shoe to be used up. This prediction can be extrapolated from the current estimation of brake wear based on the rate of wear from installation to the present. The extrapolation may also be adjusted based on train specific statistics accumulated over time, such as historical braking application in the upcoming routes to which the rail car is assigned. The predicted service date in database 20 will thus become more accurate as the service date approaches, thereby allowing for more proactive logistical planning with respect to the routes where rail car 12 is placed into service to ensure that it will be close to a service location when rail car 12 is due to be serviced.

As an example, two important characteristics of a brake shoe are the usable brake shoe volume (normally specified as a number of cubic inches of friction material) and the effort-specific wear rate. Both are normally be provided by the manufacturer as part of the engineering specifications of the brake shoe. Based on these two values, the brake shoe wear due to a particular brake application event may be calculated as:

$${dV}_{i , n} = {λ}_{i} {\int }_{t = 0}^{{T}_{n}} {E}_{i} ( t ) dt$$

where λᵢ is the effort specific wear rate for the braking system of car i, normally specified as a number of cubic inches per (horsepower*hour), Tₙ is the duration over which the brake application event n occurs and Ei is the braking effort supplied by the braking system of car i during the brake application event.

Train control system 16, as part of normal operations, may estimate the instantaneous braking effort supplied by each railcar in the train. The instantaneous braking effort is estimated by modeling the pneumatic braking system (including the train's brake pipe and the various cylinder volumes of the locomotives and railcars) and extracting from that the force applied by the railcars' brake cylinders. Thus, the integrated braking effort above can be calculated by train control system 16 and provided to database 20 for use by prediction algorithm.

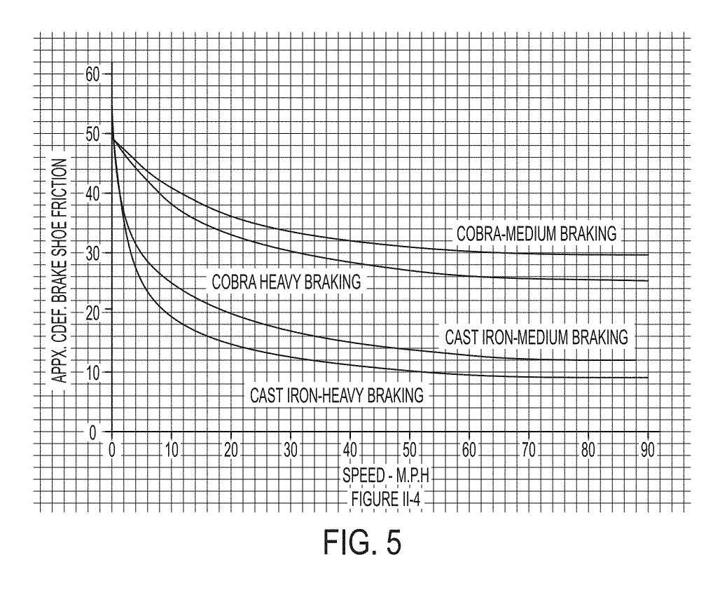

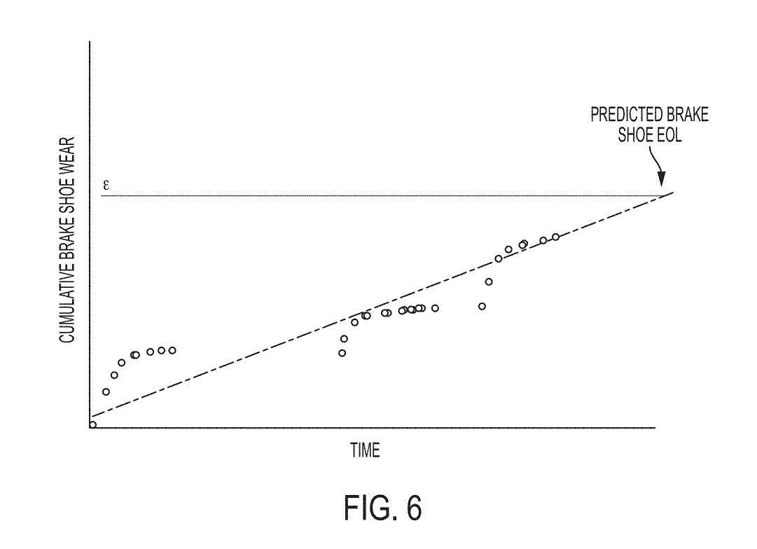

The frictional characteristic of a brake shoe can be expressed as a function of the wheel velocity using standard industry tables, such as that seen in FIG. 5. Using the frictional coefficient determined from a table such as that seen in FIG. 5 and elementary coulomb friction models, i.e., F_{f}=μ−F_{N}, the braking effort supplied by the braking system of the railcar can be estimated. The brake shoe can be considered to be degraded when

$${V}_{i} - {\sum }_{n}^{N} {dV}_{i , n} < ɛ$$

where N represents all brake application events participated in by the braking system of car i, Vᵢ represents the usable brake shoe volume, and E represents some safety threshold for minimum remaining brake shoe volume. Remaining brake shoe life may be calculated by plotting the accumulated brake shoe wear at the instants when it is changing (i.e., during braking application events) and compute the linear regression for those points. The resulting line would then serve as the prediction horizon and could be used to extrapolate when the above described degradation state will be reached, as seen in FIG. 6. This approach relies upon the railcar running either periodically over the same terrain with a similar consist in each run (i.e. a unit train) or a similar case in which the coefficient of determination for the linear regression is relatively high. Otherwise, the predictive power of such a technique is likely to be limited.

Another possible way of using the calculations is to use historical run data (accumulated by train control system 16 during normal usage) to determine an average amount of braking effort per gross train weight needed to traverse a given track segment and an average velocity profile for traversal of said segment as well as a statistical variation (standard deviation, etc.) for both of these metrics. Prior to a train run, system 10 can cross-reference the railcars in the train with the accumulated brake shoe wear database and the historical run database to estimate the amount of wear that the brake system of each railcar is likely to undergo as a result of participating in the pending run. System 10 could then determine the likelihood (using the variation data) that any of the railcars in the prospective train will approach the threshold for minimum remaining brake shoe volume and recommend maintenance as described above. Assuming that planning data is available sufficiently far into the future, the horizon for meaningful prediction of brake system maintenance can be extended.

In an alternative to using a historical database of run data (especially because the variability from run-to-run over a given segment of track may be high, particularly due to consist variability), train control system 16 may be used in a pure simulation mode to predict the magnitude and number of braking events likely to be necessary for a prospective train run. Again, assuming that planning data is available sufficiently far into the future, this approach can be used to extrapolate to the point where insufficient remaining brake shoe volume will remain. Because of the nature of this method, there will be no estimate of the statistical certainty of the prediction because only a single sample is used for prediction.

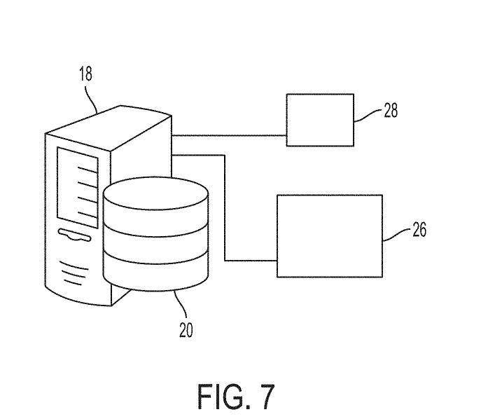

Referring to FIG. 7, system 10 may optionally include a parts module 26 that tracks the equipment that is due to be serviced across all rail cars 12 by preparing a report of equipment that is likely to become due over an upcoming time period, such as the next 90 days. Parts module 26 may thus be used by those responsible for performing maintenance on rail cars 12 to ensure that adequate inventory is on hand. Parts module 26 can also be configured to include a communication interface 28 that allows system 10 to communicate directly with a parts vendor to automatically order part needs for an upcoming maintenance period, such as 60 or 90 days. For example, interface 28 may comprise an internet connection that allows system 10 to communicate with a vendor system that is also online. As system 10 also tracks the location of rail car 12, the appropriate maintenance facilities can be automatically notified of upcoming service and the necessary parts can be routed accordingly by communicating with the appropriate systems via interface 28.

As described above, the present invention may be a system, a method, and/or a computer program associated therewith and is described herein with reference to flowcharts and block diagrams of methods and systems. The flowchart and block diagrams illustrate the architecture, functionality, and operation of possible implementations of systems, methods, and computer programs of the present invention. It should be understood that each block of the flowcharts and block diagrams can be implemented by computer readable program instructions in software, firmware, or dedicated analog or digital circuits. These computer readable program instructions may be implemented on the processor of a general purpose computer, a special purpose computer, or other programmable data processing apparatus to produce a machine that implements a part or all of any of the blocks in the flowcharts and block diagrams. Each block in the flowchart or block diagrams may represent a module, segment, or portion of instructions, which comprises one or more executable instructions for implementing the specified logical functions. It should also be noted that each block of the block diagrams and flowchart illustrations, or combinations of blocks in the block diagrams and flowcharts, can be implemented by special purpose hardware-based systems that perform the specified functions or acts or carry out combinations of special purpose hardware and computer instructions.

What is claimed is:

1. A predictive maintenance system, comprising:
a server configured to receive run data relating to a train including at least one rail car from a train control system associated with the train;
a database associated with the server and containing identifying information about the rail car, status information about an item of equipment on the rail car, a date when the item of equipment is due to be serviced, and a current location of the rail car;
wherein the server is programmed to update the status information, the date when the item of equipment is due to be serviced, and the current location of the rail based upon the run data received from the train control system.

2. The system of claim 1, wherein the identifying information comprises a rail car identification number.

3. The system of claim 2, wherein the item of equipment comprises a brake shoe.

4. The system of claim 3, wherein the run data comprises the load carried by the rail car, the speed of the rail car, and the amount of braking effort provided by the rail car.

5. The system of claim 4, wherein the date when the item of equipment is due to be serviced is calculated from the run data by determining the estimated amount of wear that has occurred based on the load carried by the rail car, the speed of the rail car, and the amount of braking effort provided by the rail car.

6. The system of claim 5, wherein the date when the item of equipment is due to be serviced is calculated by subtracting the estimated amount of wear of the brake shoe from a lifetime amount of wear for the brake shoe to determine an amount of wear remaining.

7. The system of claim 1, wherein the server is programmed predict how much time remains before the item of equipment will need to be serviced by determining an accumulated amount of wear over a series of braking events and extrapolating when the accumulated amount of wear of the brake shoe will reach a total amount of allowable wear.

8. The system of claim 7, wherein the run data is provided prior to any departure of the train and the server is programmed to perform a simulation of the operation of the train according to the run data to determine the amount of wear that will occur and whether the amount of wear that will occur will exceed the total amount of allowable wear.

9. A method of predicting when rail car equipment will need maintenance, comprising the steps of:
providing a server configured to receive run data relating to a train including at least one rail car from a train control system and a database associated with the server and containing identifying information about the rail car, status information about an item of equipment on the rail car, a date when the item of equipment is due to be serviced, and a current location of the rail car;
calculating the amount of wear that the item of equipment will experience based on the run data;
updating the status information, the date when the item of equipment is due to be serviced, and the current location of the rail upon receipt of run data from the train control system based on the calculation of the amount of wear that the item of equipment will experience.

10. The method of claim 9, wherein the identifying information comprises a rail car identification number.

11. The method of claim 10, wherein the item of equipment comprises a brake shoe.

12. The method of claim 11, wherein the run data comprises the load carried by the rail car, the speed of the rail car, and the amount of braking effort provided by the rail car.

13. The method of claim 9, further comprising the step of predicting how much time remains before the item of equipment will need to be serviced.

14. The method of claim 13, where the step of the step of predicting how much time remains before the item of equipment will need to be serviced comprises determining an accumulated amount of wear over a series of braking events and extrapolating when the accumulated amount of wear of the brake shoe will reach a total amount of allowable wear.

15. The method of claim 14, The system of claim 7, wherein the run data is provided to the server prior to any departure of the train and the step of server predicting how much time remains before the item of equipment will need to be serviced comprises performing a simulation of the operation of the train according to the run data to determine the amount of wear that will occur and whether the amount of wear that will occur will exceed the total amount of allowable wear.
